(19) United States
(12) Patent Application Publication
(10) Pub. No.: US 2026/0237932 A1
(43) Pub. Date: Aug. 13, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yunosuke YAMASAKI, Mie (JP); Tetsuya MIYAMURA, Mie (JP); Akiko SUZUKI, Mie (JP)

(21) Appl. No.: 19/153,339

(22) PCT Filed: Jan. 17, 2024
(86) PCT No.: PCT/JP2024/001082

§ 371 Date: Aug. 4, 2025

(30) Foreign Application Priority Data
Feb. 6, 2023 (JP) 2023-015787

(51) Int. Cl. H01R 13/436

(52) U.S. Cl. CPC H01R 13/4362

(57) ABSTRACT

A connector is for holding a terminal including a mating terminal connecting portion and a crimping portion to be crimped to a wire end, and includes a housing formed with a cavity capable of accommodating the terminal and a terminal holding member mountable on the housing at a primary locking position and a secondary locking position. The terminal holding member includes a locking lance temporarily lockable to the terminal in the cavity at the primary locking position and a locking protrusion lockable to the terminal in the cavity at the secondary locking position. The locking lance includes a retracting protrusion having a retracting contact surface.

### TECHNICAL FIELD

The present disclosure relates to a connector.

### BACKGROUND

Patent Document 1 discloses that a locking lance for locking and fixing a terminal fitting extends obliquely forward at a substantially center position of the lower surface of a terminal accommodation chamber of a housing body and a tip side of the locking lance is formed to be resiliently deformable downward and resiliently engageable with a lance hole provided in the terminal fitting.

### PRIOR ART DOCUMENT

### Patent Document

Patent Document 1: JP 2001-345139 A

### SUMMARY OF THE INVENTION

### Problems to be Solved

Here, it is desired to further reduce the size of a connector capable of primarily and secondarily locking a terminal.

Accordingly, the present disclosure aims to further reduce the size of a connector capable of primarily and secondarily locking a terminal.

### Means to Solve the Problem

The present disclosure is directed to a connector for holding a terminal including a mating terminal connecting portion and a crimping portion to be crimped to a wire end, the connector being provided with a housing formed with a cavity capable of accommodating the terminal and a terminal holding member mountable on the housing at a primary locking position and a secondary locking position, the terminal holding member including a locking lance temporarily lockable to the terminal in the cavity at the primary locking position and a locking protrusion lockable to the terminal in the cavity at the secondary locking position, the locking lance including a retracting protrusion having a retracting contact surface, and the retracting contact surface being formed at a position where the retracting contact surface contacts the crimping portion to resiliently deform the locking lance in a direction separating from the terminal by a movement of the terminal holding member from the primary locking position to the secondary locking position.

### Effect of the Invention

According to the present disclosure, a connector capable of primarily and secondarily locking a terminal can be further reduced in size.

### BRIEF DESCRIPTION OF THE DRAWINGS

FIG. 1 is a perspective view of a connector according to an embodiment.

FIG. 2 is an exploded perspective view showing the connector.

FIG. 3 is an exploded perspective view showing the connector.

FIG. 4 is a partial section along IV-IV of FIG. 1.

FIG. 5 is a perspective view showing the connector.

FIG. 6 is a section along VI-VI of FIG. 5.

FIG. 7 is a section along VII-VII of FIG. 6.

FIG. 8 is a section along VIII-VIII of FIG. 6.

FIG. 9 is a perspective view showing a positional relationship of a locking lance and a terminal.

### DETAILED DESCRIPTION TO EXECUTE THE INVENTION

### Description of Embodiments of Present Disclosure

First, embodiments of the present disclosure are listed and described.

The connector of the present disclosure is as follows.
(1) The connector of the present disclosure is for holding a terminal including a mating terminal connecting portion and a crimping portion to be crimped to a wire end, and provided with a housing formed with a cavity capable of accommodating the terminal and a terminal holding member mountable on the housing at a primary locking position and a secondary locking position, the terminal holding member including a locking lance temporarily lockable to the terminal in the cavity at the primary locking position and a locking protrusion lockable to the terminal in the cavity at the secondary locking position, the locking lance including a retracting protrusion having a retracting contact surface, and the retracting contact surface being formed at a position where the retracting contact surface contacts the crimping portion to resiliently deform the locking lance in a direction separating from the terminal by a movement of the terminal holding member from the primary locking position to the secondary locking position.

According to this connector, the terminal holding member is provided with the locking lance for temporarily locking the terminal. Thus, the housing may not be provided with the locking lance and can be reduced in size. In this way, the connector capable of temporarily locking the terminal can be further reduced in size.

Further, the terminal holding member can be moved from the primary locking position to the secondary locking position while the locking lance is resiliently deformed in the direction separating from the terminal by bringing the retracting contact surface of the locking lance into contact with the crimping portion. At this time, since the retracting contact surface contacts the crimping portion, the production of shavings due to the contact of the locking lance with the terminal is suppressed.
(2) In the connector of (1), the terminal may include a recess recessed between the mating terminal connecting portion and the crimping portion, the locking lance may primarily lock the recess with the terminal holding member located at the primary locking position, and the locking protrusion may secondarily lock the recess with the terminal holding member located at the secondary locking position.

In this case, the locking lance and the locking protrusion can lock the same recess. Thus, the terminal may not be formed with a location to be primarily locked by the locking lance and a location to be secondarily locked by the locking protrusion separately. In this way, the terminal can be simplified and reduced in size, which also contributes to a size reduction of the connector.
(3) In the connector of (1) or (2), the locking lance may include a retaining protrusion located closer to the mating terminal connecting portion than the retracting protrusion, the retaining protrusion may retain and lock the mating terminal connecting portion from the crimping portion side with the terminal holding member located at the primary locking position, and the retracting protrusion may project more toward the terminal than the retaining protrusion.

In this case, since the retracting protrusion projects more toward the terminal than the retaining protrusion, the retracting protrusion is easily brought into contact with the terminal while the contact of the retaining protrusion and the terminal is avoided.
(4) In the connector of (3), the retracting protrusion may project more than the retaining protrusion in a moving direction of the terminal holding member from the primary locking position to the secondary locking position and a direction toward the terminal orthogonal to the moving direction.

In this case, the retracting protrusion easily contacts the crimping portion earlier than the retaining protrusion, the contact of the retaining protrusion and a pair of side walls is more reliably avoided and the production of shavings due to the contact of the locking lance with the terminal is more reliably suppressed.
(5) In the connector of (3) or (4), the terminal may include a coupling portion coupling the mating terminal connecting portion and the crimping portion, the coupling portion may include a bottom portion and a pair of side walls rising from both side edges of the bottom portion, and the retracting contact surface may contact the crimping portion to avoid contact of the retaining protrusion and the pair of side walls when the terminal holding member moves from the primary locking position to the secondary locking position.

In this way, the contact of the retaining protrusion and the pair of side walls is avoided, and the production of shavings due to the contact of the locking lance with the terminal is more reliably suppressed.
(6) In the connector of any one of (1) to (5), the locking lance may include a terminal insertion guide protrusion located on a side opposite to the mating terminal connecting portion with respect to the retracting protrusion, and the terminal insertion guide protrusion may have a terminal insertion guide surface extending in a direction away from the terminal toward the side opposite to the mating terminal connecting portion in an extension direction of the cavity.

In this case, if the terminal is inserted into the cavity with the terminal holding member mounted on the housing at the primary locking position, the terminal contacts the terminal insertion guide surface. In this way, the locking lance can be resiliently deformed in the direction away from the terminal. In this way, the terminal can be easily inserted into the cavity.
(7) In the connector of any one of (1) to (6), at least a part of the locking lance may be arranged at a position capable of contacting the terminal in the cavity with the terminal holding member mounted on the housing at the secondary locking position.

In this way, with the terminal holding member located at the secondary locking position, at least a part of the locking lance can support the terminal in the cavity and the terminal is stabilized in the cavity.
(8) In the connector of any one of (1) to (7), the housing may include a secondary locking opening and a primary locking opening, the terminal holding member may include a terminal holding body to be mounted into the secondary locking opening and a pair of locking wall portions extending along both sides of the housing from both sides of the terminal holding body, the locking protrusion may be formed to project into the cavity from the terminal holding body, and the locking lance may project in the same direction as each of the pair of locking wall portions from the terminal holding body to be arrangeable in the primary locking opening and be resiliently deformed along a direction intersecting an extension direction of the cavity.

In this case, the locking lance is formed to project in the same direction as the locking wall portions from the terminal holding body to be arrangeable in the primary locking opening and resiliently deformed in the direction intersecting the extension direction of the cavity. Thus, a configuration for forming the locking lance can be reduced as compared to the case where the locking lance is set in a posture along the extension direction of the cavity. In this way, the connector can be reduced in size in a front-rear direction.
(9) In the connector of (8), the housing may include an inner cavity located closer to the terminal holding body than the cavity, and the locking lance may extend to avoid locking with a terminal arranged in the inner cavity, out of a plurality of the terminals.

In this case, if the terminal is inserted into the inner cavity after the terminal is inserted into the cavity and the locking lance primarily locks the terminal and, thereafter, the terminal holding member is moved from the primary locking position to the secondary locking position, the escape of the terminal in the inner cavity can be suppressed. Thus, a configuration for primarily locking the terminal in the inner cavity can be made unnecessary, and the connector can be further simplified and reduced in size.
(10) In the connector of (8) or (9), the locking protrusion may project from the terminal holding body at a position separated from the locking lance.

In this case, since the locking protrusion projects from the terminal holding body at the position separated from the locking lance, the locking lance is easily resiliently deformed.
(11) In the connector of any one of (8) to (10), the pair of locking wall portions may respectively include mounting locking protrusions to be secondarily locked to the both sides of the housing at positions on both outer sides of the primary locking opening along the extension direction of the cavity.

In this case, since the pair of locking wall portions are respectively secondarily locked to the both sides of the housing at the positions on the both outer sides of the primary locking opening along the extension direction of the cavity, the terminal holding member can be firmly held on the housing.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

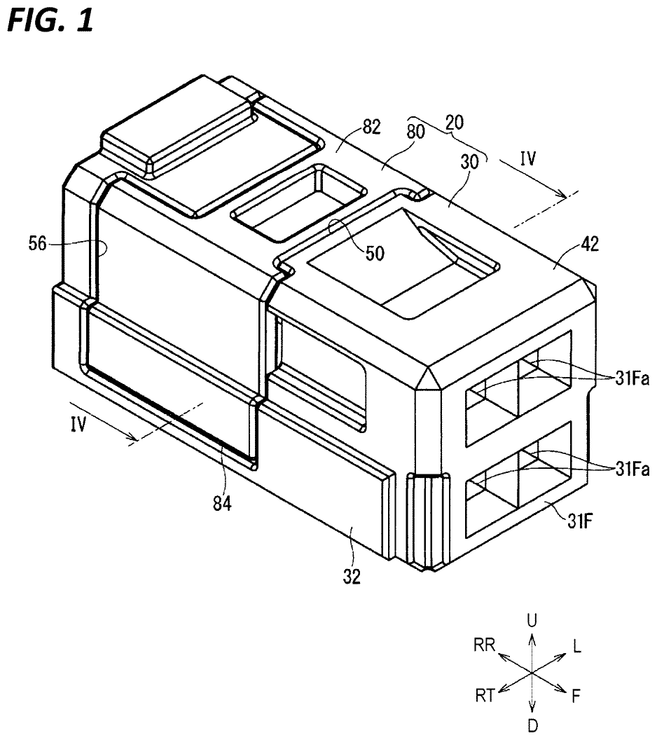

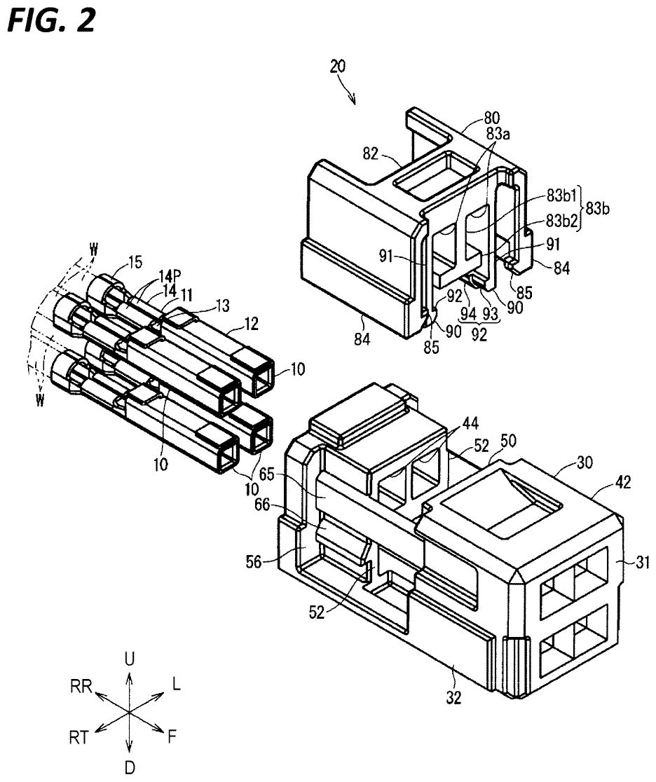

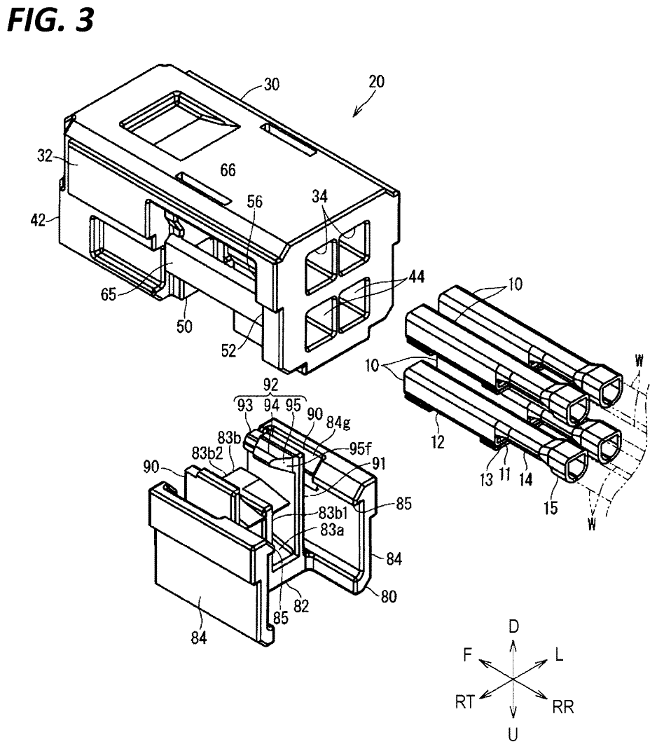

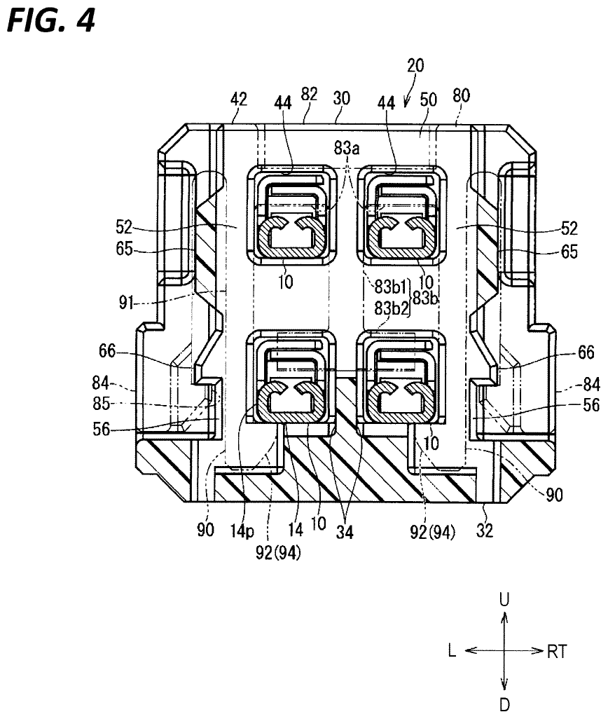

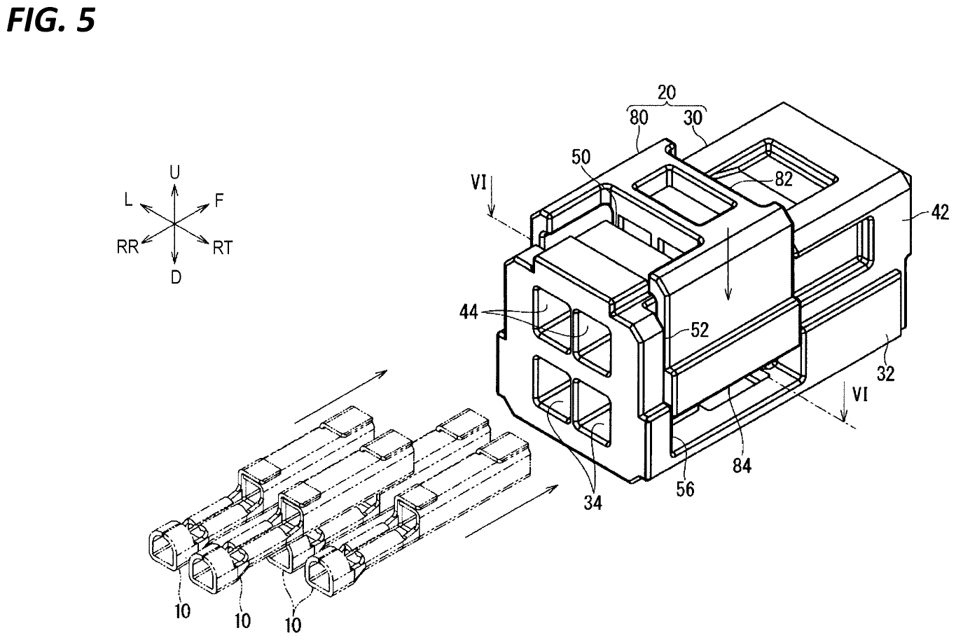

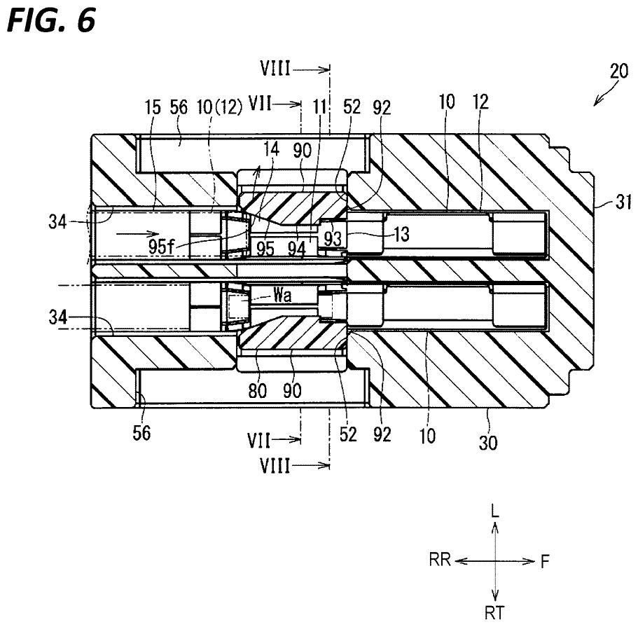

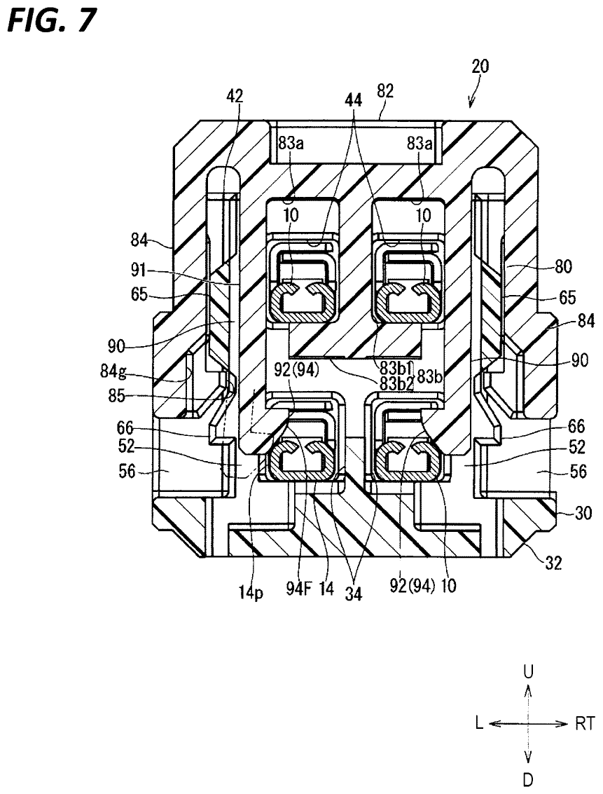

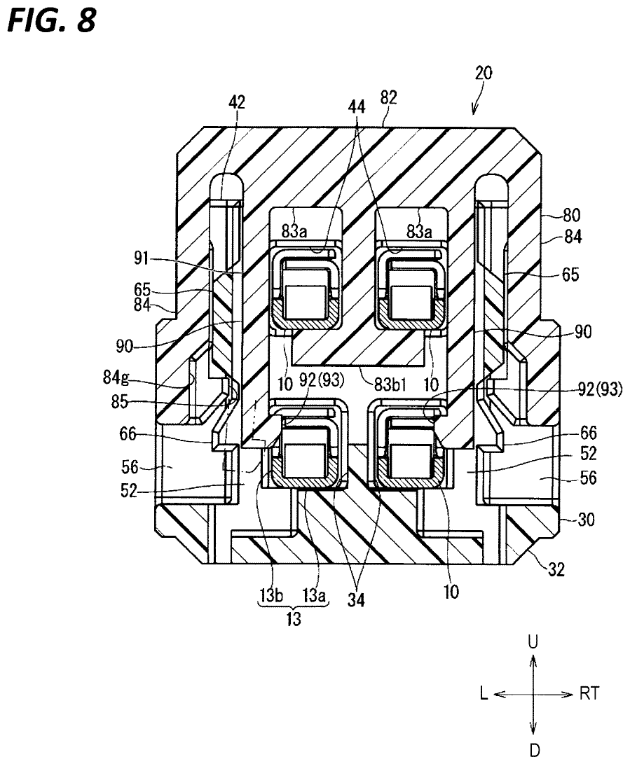

Hereinafter, a connector according to an embodiment is described. FIG. 1 is a perspective view of a connector 20. FIGS. 2 and 3 are exploded perspective views showing the connector 20. FIG. 4 is a partial section along IV-IV of FIG. 1. In FIG. 4, a terminal holding member 80 is shown by two-dot chain lines. In FIGS. 1 to 4, the terminal holding member 80 is located at a secondary locking position. FIG. 5 is a perspective view showing the connector 20. In FIG. 5, terminals 10 to be inserted into cavities 34, 44 are shown by two-dot chain lines. FIG. 6 is a section along VI-VI of FIG. 5. FIG. 7 is a section along VII-VII of FIG. 6, and FIG. 8 is a section along VIII-VIII of FIG. 6. In FIGS. 5 to 8, the terminal holding member 80 is located at a primary locking position.

### <Overall Structure of Connector>

The overall structure of the connector 20 is described. The connector 20 is connected to a mating connector while holding the terminals 10.

The terminal 10 is formed, such as by press-working a metal plate. The terminal 10 is provided with a mating terminal connecting portion 12 and crimping portions 14, 15 (see FIG. 2). The mating terminal connecting portion 12 is a part to be connected to a mating terminal and, for example, formed into a tubular shape, more specifically a rectangular tube shape. The crimping portions 14, 15 are parts to be crimped to an end part of a wire W. In this embodiment, the terminal 10 includes a core wire crimping portion 14 and a coating crimping portion 15. The core wire crimping portion 14 is a part to be crimped to a core wire portion Wa (see the right terminal 10 of FIG. 6) exposed in the end part of the wire W. The coating crimping portion 15 is a part to be crimped to a coating portion in the end part of the wire W.

The mating terminal connecting portion 12, the core wire crimping portion 14 and the coating crimping portion 15 are linearly arranged in this order. Thicknesses of the mating terminal connecting portion 12 and the coating crimping portion 15 are larger than that of the core wire crimping portion 14. Thus, if the terminal 10 is observed laterally, a recess 11 recessed in a part of the terminal 10 in an extension direction is formed above the core wire crimping portion 14 and between the mating terminal connecting portion 12 and the coating crimping portion 15.

The core wire crimping portion 14 includes a pair of crimping pieces 14p to be crimped to the core wire portion Wa. The crimping piece 14p is bent into a curved surface convex outward with respect to the core wire portion Wa. Thus, upper parts of both sides of the core wire crimping portion 14 form curved surfaces convex outward. The coating crimping portion 15 also includes a pair of crimping pieces to be crimped to the coating portion, similarly to the core wire crimping portion 14.

A coupling portion 13 is interposed between the mating terminal connecting portion 12 and the core wire crimping portion 14. The coupling portion 13 couples the mating terminal connecting portion 12 and the core wire crimping portion 14. The coupling portion 13 includes a bottom portion 13a and a pair of side walls 13b rising from both side edges of the bottom portion 13a.

The bottom portion 13a is connected to a bottom plate part of the mating terminal connecting portion 12 and a bottom plate part of the core wire crimping portion 14. The pair of side walls 13b are connected to bottom parts of a pair of side wall parts of the mating terminal connecting portion 12 and base end side parts of the pair of crimping pieces 14p. Since the coupling portion 13 includes the bottom portion 13a and the pair of side walls 13b, the mating terminal connecting portion 12 and the core wire crimping portion 14 are easily held in a straight state.

In this embodiment, the connector 20 holds a plurality of the terminals 10. More specifically, a plurality of (e.g. two) terminals 10 are held separately in a plurality of stages (e.g. 2 stages). In each stage, the plurality of terminals 10 are arranged in parallel in a row. Note that the plurality of terminals 10 may have the same size, material and the like or may have different sizes, materials and the like. Note that the number of the terminals 10 to be held by the connector 20 is arbitrary.

The connector 20 is provided with a housing 30 and the terminal holding member 80. The plurality of terminals 10 at least in one stage are held not to come out from the housing 30 by the terminal holding member 80. In this embodiment, the terminal holding member 80 holds the terminals 10 in the plurality of stages. The terminal holding member 80 may be called a retainer.

In the following description, in the extension direction of the terminal 10, the side of the mating terminal connecting portion 12 may be referred to as a front side and the side of the crimping portions 14, 15 may be referred to as a rear side. Further, the side of the terminal holding member 80 with respect to the housing 30 may be referred to as an upper side and an opposite side thereof may be referred to as a lower side. Further, a lateral direction may be referred to on the basis of the front, rear, upper and lower sides.

The housing 30 is made of resin or the like and provided with terminal accommodating portions 32, 42. In this embodiment, the housing 30 is provided with the terminal accommodating portion 32 on the lower side and the terminal accommodating portion 42 on the upper side. The lower terminal accommodating portion 32 includes cavities 34 for accommodating the terminals 10. In this embodiment, the lower terminal accommodating portion 32 includes a plurality of (here, two) cavities 34 arranged in parallel. The upper terminal accommodating portion 42 includes inner cavities 44 for accommodating the terminals 10. In this embodiment, the upper terminal accommodating portion 42 includes a plurality of (here, two) inner cavities 44 arranged in parallel. The inner cavities 44 are located closer to a terminal holding body 82 of the terminal holding member 80 than the cavities 34.

The terminal holding member 80 is configured to be mountable on the housing 30 at a primary locking position and a secondary locking position.

Secondary locking means the locking of the terminals 10 by the terminal holding member 80 with such a force that the terminals 10 can be suppressed from coming out from the housing 30 when the connector 20 is inserted into and withdrawn from the mating connector. The secondary locking position is a position where the terminal holding member 80 can secondarily lock each of the terminals 10 in the cavities 34 and the terminals 10 in the inner cavities 44.

Primary locking means the temporary locking of the terminals 10 by the terminal holding member 80 in a state before the terminal holding member 80 primarily locks the terminals 10. The primary locking position is a position where the terminal holding member 80 can primarily lock the terminals 10 in the cavities 34. A holding force for holding the terminals 10 by primary locking may be such a force capable of suppressing the terminals 10 from coming out during an operation of inserting the terminals 10 into the inner cavities 44 and during an operation of moving the terminal holding member 80 to the secondary locking position. The holding force for holding the terminals 10 by primary locking may be smaller than that for holding the terminals 10 by secondary locking.

If the terminal 10 is inserted into the cavity 34 with the terminal holding member 80 mounted on the housing 30 at the primary locking position, the terminal holding member 80 primarily locks the terminal 10. In this way, the terminal 10 is suppressed from coming out from the cavity 34. In this state, the terminals 10 can be easily inserted into the inner cavities 44. Thereafter, if the terminal holding member 80 is moved from the primary locking position to the secondary locking position, the terminal holding member 80 can secondarily lock the terminals 10 in the cavities 34 and the terminals 10 in the inner cavities 44.

In this embodiment, it is not essential that the housing 30 is provided with the inner cavities 44. That is, the connector 20 may be configured to include cavities in one stage.

### <Concerning Terminal Holding Structure by Terminal Holding Member>

As described above, in the housing 30, the plurality of inner cavities 44 and the plurality of cavities 34 are arranged in upper and lower stages. A front plate portion 31F extending in directions orthogonal to the front-rear direction is provided on the front edge of the housing 30. The front plate portion 31F is located on the front ends of the cavities 34, 44. The terminals 10 arranged in the cavities 34, 44 are restricted from moving forward by contacting the front plate portion 31F. The front plate portion 31F is formed with connection holes 31Fa, through which mating terminals (e.g. male terminals each including an elongated plate portion or a pin-shaped part) are insertable. The mating terminals can be connected to the terminals 10 in the cavities 34, 44 through the connection holes 31Fa.

The cavities 34, 44 are open rearward. The terminals 10 are inserted and arranged in the cavities 34, 44 through rear openings.

The housing 30 includes secondary locking openings 52 and a primary locking opening 50.

The secondary locking openings 52 are openings for allowing the terminal holding member 80 to secondarily lock the terminals 10. In this embodiment, the secondary locking opening 52 is an opening for causing intermediate regions in an extension direction of the cavities 34, 44 to be open upward. The secondary locking opening 52 is an opening extending from an opening formed above the inner cavity 44 to an opening formed in a partition between the inner cavity 44 and the cavity 34. The recesses 11 of the terminals 10 arranged in the cavities 34, 44 can be exposed upward via the secondary locking openings 52. Inner locking protrusions 83a and a locking protrusion 83b of the terminal holding member 80 to be described later are arranged at positions capable of secondarily locking the terminals 10 in the cavities 34, 44 through the secondary locking openings 52.

The primary locking opening 50 is an opening for causing the terminal holding member 80 to primarily lock the terminals 10. In this embodiment, the primary locking opening 50 is formed in intermediate regions in the extension direction of the cavities 34, 44. The primary locking opening 50 extends along the vertical direction and is open upward on both outer positions of the cavities 34, 44. The recesses 11 of the terminals 10 arranged in the cavities 34, 44 can be exposed laterally via the primary locking opening 50. Locking lances 90 of the terminal holding member 80 to be described later can primarily lock the terminals 10 in the cavities 34 by being arranged in the primary locking opening 50 from above.

A pair of locking recesses 56 are formed in both side parts of the housing 30. The locking recesses 56 are partially recessed in intermediate parts in the extension direction of the cavities 34, 44. In this embodiment, the locking recesses 56 are formed in regions corresponding to parts of the terminals 10 in the cavities 34, 44 behind the mating terminal connecting portions 12. Locking wall portions 84 of the terminal holding member 80 are respectively arranged in the pair of locking recesses 56. The locking recesses 56 spread further rearward than the primary locking opening 50 and the secondary locking openings 52, but this configuration is not essential.

A primary locking protrusion 65 and a secondary locking protrusion 66 are formed in the locking recess 56.

The primary locking protrusion 65 is a part to be locked to the locking wall portion 84 of the terminal holding member 80 with the terminal holding member 80 located at the primary locking position. The primary locking protrusion 65 projects outward from the bottom surface of the locking recess 56. The primary locking protrusion 65 is an elongated protrusion extending along the extension direction of the cavity 34. The primary locking protrusion 65 extends outside the primary locking opening 50 in the front-rear direction in the extension direction of the cavity 34. Thus, the locking wall portion 84 can lock the primary locking protrusion 65 at both positions outside the primary locking opening 50 in the front-rear direction along the extension direction of the cavity 34.

In this embodiment, the primary locking protrusion 65 passes outside the primary locking opening 50 along the extension direction of the cavity 34. Thus, front and rear parts of the primary locking opening 50 and the secondary locking opening 52 are coupled by the primary locking protrusion 65. The primary locking protrusion may be omitted outside the primary locking opening 50.

An upper part of the primary locking protrusion 65 is formed into such a shape that a projecting dimension becomes gradually smaller toward the upper side. In this way, the locking wall portion 84 easily rides over the primary locking protrusion 65. A lower part of the primary locking protrusion 65 may be formed into such a shape that a projecting dimension becomes gradually smaller toward the lower side or may be formed into a shape perpendicular to the bottom surface of the locking recess 56.

The secondary locking protrusion 66 is a part to be locked to the locking wall portion 84 of the terminal holding member 80 with the terminal holding member 80 located at the secondary locking position. The secondary locking protrusion 66 projects outward from the bottom surface of the locking recess 56. The secondary locking protrusion 66 is an elongated protrusion extending along the extension direction of the cavity 34. The secondary locking protrusion 66 extends outside the primary locking opening 50 in the front-rear direction in the extension direction of the cavity 34. Thus, the locking wall portion 84 can lock the secondary locking protrusion 66 at both positions outside the primary locking opening 50 in the front-rear direction along the extension direction of the cavity 34.

In this embodiment, the secondary locking protrusion 66 is not provided outside the primary locking opening 50. Thus, a space for enabling the locking lance 90 to be described later to be displaced outward in the lateral direction is easily secured. The secondary locking protrusion 66 may pass outside the primary locking opening 50.

An upper part of the secondary locking protrusion 66 is formed into such a shape that a projecting dimension becomes gradually smaller toward the upper side. In this way, the locking wall portion 84 easily rides over the secondary locking protrusion 66. A lower part of the secondary locking protrusion 66 may be formed into such a shape that a projecting dimension becomes gradually smaller toward the lower side or may be formed into a shape perpendicular to the bottom surface of the locking recess 56. In this embodiment, the lower part of the secondary locking protrusion 66 is formed into the shape perpendicular to the bottom surface of the locking recess 56, more specifically a surface orthogonal to a setting direction of the terminal holding member 80.

The primary locking protrusion 65 is located above the secondary locking protrusion 66. In this embodiment, the primary locking protrusion 65 is located above a partition part between the cavities 34 and 44, and the secondary locking protrusion 66 is located laterally outward of the cavity 34. The locking wall portion 84 to be inserted from up to down along the vertical direction can secondarily lock the secondary locking protrusion 66 after primarily locking the primary locking protrusion 65.

The terminal holding member 80 includes the terminal holding body 82 and a pair of the locking wall portions 84.

The terminal holding body 82 is a part to be mounted into upper recessed parts of the secondary locking openings 52. Here, the terminal holding body 82 is in the form of a plate spreading in a size capable of collectively closing upper recessed parts of the secondary locking openings 52 corresponding to the plurality of inner cavities 44. With the terminal holding body 82 arranged in the upper recessed parts of the secondary locking openings 52, the front and rear ends of the terminal holding body 82 are in contact with end surfaces facing the upper recessed parts, out of a ceiling part of the housing. In this way, the terminal holding member 80 is positioned in the front-rear direction.

The terminal holding body 82 is formed with the inner locking protrusions 83a and the locking protrusion 83b projecting toward the cavities 34, 44.

The inner locking protrusion 83a is a part for secondarily locking the recess 11 of the terminal 10 in the inner cavity 44. More specifically, the inner locking protrusion 83a projects into the inner cavity 44 from an inward facing part of the terminal holding body 82. With the terminal holding member 80 located at the primary locking position, the inner locking protrusions 83a are located inside the inner cavities 44 to allow the insertion of the terminals 10 into the inner cavities 44. With the terminal holding member 80 located at the secondary locking position, the inner locking protrusions 83a partially enter the inner cavities 44 and are arranged in the recesses 11 of the terminals 10. In this way, the inner locking protrusions 83a are arranged at positions capable of contacting the mating terminal connecting portions 12 from behind and prevent the terminals 10 from coming out rearward. A rear part of the inner locking protrusion 83a may be formed into such a shape that a projecting dimension becomes gradually smaller toward the rear side. In this way, even if the terminal 10 contacts the inner locking protrusion 83a when the terminal 10 is inserted into the inner cavity 44, this terminal 10 contacts the rear part of the inner locking protrusion 83a and the terminal holding member 80 is lifted upward. In this way, the terminal 10 is easily inserted into the inner cavity 44 while avoiding the interference of the terminal 10 and the inner locking protrusion 83a.

The locking protrusion 83b is a part for secondarily locking the recesses 11 of the terminals 10 in the cavities 34. More specifically, the locking protrusion 83b includes an intermediate wall portion 83b1 and a retaining portion 83b2.

The intermediate wall portion 83b1 projects downward from an intermediate part in a width direction of the terminal holding body 82. The intermediate wall portion 83b1 is formed at a position corresponding to a partition between the plurality of inner cavities 44. Thus, the intermediate wall portion 83b1 can extend toward the cavities 34 through between the plurality of inner cavities 44.

The retaining portion 83b2 projects in the lateral direction from a lower end part of the intermediate wall portion 83b1. A thickness in the vertical direction of the retaining portion 83b2 is smaller than a thickness of the partition between the cavities 34 and the inner cavities 44. With the terminal holding member 80 located at the primary locking position, the retaining portion 83b2 is located between the cavities 34 and the inner cavities 44 and hardly hinders the insertion of the terminals 10 into the corresponding cavities 34 and inner cavities 44. With the terminal holding member 80 located at the secondary locking position, the retaining portion 83b2 is located in the cavities 34 and enter the recesses 11 of the terminals 10 in the cavities 34. In this way, the retaining portion 83b2 of the locking protrusion 83b is arranged at a position capable of contacting the mating terminal connecting portions 12 from behind and prevents the terminals 10 from coming out rearward. A rear part of a lower part of the retaining portion 83b2 may be shaped to extend gradually upward toward the rear side. In this way, even if the terminal 10 contacts the retaining portion 83b2 when being inserted into the cavity 34, this terminal 10 contacts the rear part of the lower part of the retaining portion 83b2 and the terminal holding member 80 is lifted upward. In this way, the terminal 10 is easily inserted into the cavity 34 while avoiding the interference of the terminal 10 and the locking protrusion 83b.

The pair of locking wall portions 84 are in the form of plates extending along both sides of the housing 30 from both sides of the terminal holding body 82. Mounting locking protrusions 85 are formed at positions near tips on the inner surfaces of the pair of locking wall portions 84. The mounting locking protrusion 85 is a protrusion projecting from the inner surface of the locking wall portion 84. A lower part of the mounting locking protrusion 85 is formed into a shape including a part with a projecting dimension gradually reduced toward a tip side of the locking wall portion 84. The pair of locking wall portions 84 can be selectively locked to a pair of the primary locking protrusions 65 and a pair of secondary locking protrusions 66.

The mounting locking protrusion 85 may have a protrusion shape elongated along the extension direction of the cavity 34. In this embodiment, the mounting locking protrusion 85 may be formed at a position avoiding the primary locking opening 50, i.e. at each of positions in front of and behind the primary locking opening 50. Thus, the mounting locking protrusions 85 can be stably locked to the primary locking protrusion 65 or the secondary locking protrusion 66 at the positions in front of and behind the primary locking opening 50.

A retraction recess 84g is formed in a region of the locking wall portion 84 outside the cavity 34 and outside the primary locking opening 50. The retraction recess 84g is located outside a tip part of the locking lance 90 to be described later. Thus, the locking lance 90 can be displaced in a direction retracting from the cavity 34 while partially entering the retraction recess 84g.

The terminal holding member 80 includes a pair of the locking lances 90 capable of temporarily locking the terminals 10 in the cavities 34 at the primary locking position. The right locking lance 90 temporarily locks the terminal 10 in the right cavity 34, and the left locking lance 90 temporarily locks the terminal 10 in the left cavity 34.

The locking lance 90 includes a retracting protrusion 94 having a retracting contact surface 94f. When the terminal holding member 80 moves from the primary locking position to the secondary locking position, the retracting contact surfaces 94f contact the core wire crimping portions 14. In this way, the locking lances 90 can be resiliently deformed in directions separating from the terminals 10, here, laterally outward.

In this embodiment, the locking lance 90 projects in the same direction as the locking wall portion 84 from the terminal holding body 82 to be arrangeable in the primary locking opening 50. With the terminal holding body 82 arranged in the upper recessed parts of the secondary locking openings 52, the locking lance 90 is arranged to extend toward the cavity 34 through the inside of the secondary locking opening 52. In this state, the locking lance 90 is set in a posture intersecting, here orthogonal to, the cavity 34 outside the cavity 34. The locking lance 90 can be resiliently deformed in a direction intersecting the extension direction of the cavity 34, i.e. in the lateral direction.

More specifically, the locking lance 90 includes a resilient piece 91 and a temporary locking protrusion 92.

The resilient piece 91 is formed to project in the same direction as the locking wall portion 84 at an intermediate position in an extension direction of the terminal holding body 82 to be arrangeable in the primary locking opening 50. The resilient piece 91 is formed at a position where the resilient piece 91 can be arranged in the primary locking opening 50 with respect to the terminal holding body 82, i.e. at a position passing outside the cavities 34, 44.

Regardless of whether the terminal holding body 80 is located at the primary locking position or at the secondary locking position, the resilient piece 91 is arranged at a position outside and avoiding the cavities 34, 44, and the temporary locking protrusion 92 is arranged below the inner cavity 44. Thus, the locking lance 90 extends to avoid locking with the terminal 10 arranged in the inner cavity 44.

A front-rear length of the resilient piece 91 is so set that the resilient piece 91 is fit in the primary locking opening 50 in the front-rear direction, and smaller than that of the locking wall portion 84. The resilient piece 91 projects further downward than the locking wall portion 84. The resilient piece 91 can be resiliently deformed in the lateral direction in the primary locking opening 50 with a base end part as a center.

The resilient piece 91 projects from the terminal holding body 82 at a position separated from the locking protrusion 83b. Thus, a resilient deformation region of the resilient piece 91 can be made larger as compared to the case where a locking protrusion is integrated with a lateral side of a base end part of a resilient piece.

The temporary locking protrusion 92 projects along the front-rear direction on the tip part of the resilient piece 91. The temporary locking protrusion 92 projects inward with respect to the resilient piece 91. With the terminal holding member 80 located at the primary locking position, the temporary locking protrusion 92 enters the cavity 34 from the inner surface of the resilient piece 91. In this way, the temporary locking protrusion 92 can primarily lock the recess 11 of the terminal 10 in the cavity 34. With the terminal holding member 80 located at the secondary locking position, the temporary locking protrusion 92 is located below the cavity 34 and the locking is released at the position corresponding to the recess 11 of the terminal 10.

When the temporary locking protrusion 92 moves downward of the terminal 10 from the recess 11 of the terminal 10, the temporary locking protrusion 92 is pressed against the terminal 10 and the resilient piece 91 is temporarily resiliently deformed outwardly of the cavity 34. By pressing the temporary locking protrusion 92 against the curved surface of the core wire crimping portion 14, the resilient piece 91 is hardly scraped and the production of shavings is suppressed.

More specifically, the temporary locking protrusion 92 includes the retracting protrusion 94 and a retaining protrusion 93 (see FIGS. 3 and 6). The retaining protrusion 93 is located closer to the mating terminal connecting portion 12, i.e. more forward, than the retracting protrusion 94.

In the extension direction of the cavity 34, the retracting protrusion 94 is formed in a region where the retracting protrusion 94 contacts the core wire crimping portion 14, more preferably located in a zone between the front and rear ends of the core wire crimping portion 14.

The retaining protrusion 93 is continuous with a front side of the retracting protrusion 94. With the terminal holding member 80 located at the primary locking position, the retaining protrusion 93 is arranged at a position to retain and lock the mating terminal connecting portion 12 from the side of the core wire crimping portion 14. In this state, the retracting protrusion 94 is located outside the core wire crimping portion 14. The retracting protrusion 94 may contact the core wire crimping portion 14 to such an extent as not to resiliently deform the resilient piece 91.

The retracting protrusion 94 projects more toward the terminal 10 than the retaining protrusion 93 (see FIGS. 3, 7 and 8). That is, the retracting protrusion 94 projects more than the retaining protrusion 93 to contact the core wire crimping portion 14 earlier and resiliently deform the resilient piece 91 when the terminal holding member 80 is moved from the primary locking position toward the primary locking position.

For example, the retracting protrusion 94 projects more than the retaining protrusion 93 in a moving direction of the terminal holding member 80 from the primary locking position to the primary locking position. Further, for example, the retracting protrusion 94 projects more than the retaining protrusion 93 in a direction toward the terminal 10 orthogonal to this moving direction. In this way, the retracting protrusion 94 can contact the core wire crimping portion 14 earlier than the retaining protrusion 93.

If the retracting protrusion 94 projects more than the retaining protrusion 93 in both the above moving direction and the direction toward the terminal 10 orthogonal to the moving direction, the retracting protrusion 94 can be more reliably brought into contact with the core wire crimping portion 14 earlier.

The retracting protrusion 94 preferably projects to such an extent as to avoid the contact of the retaining protrusion 93 and the side wall 13b when the terminal holding member 80 moves from the primary locking position to the primary locking position. This projecting extent is set in view of an interval between the coupling portions 13, the position of the upper edge of the side wall 13b, the size of the core wire crimping portion 14 and the like.

The retracting protrusion 94 has the retracting contact surface 94f facing toward the core wire crimping portion 14. The retracting contact surface 94f is preferably formed into such a shape that an inward projecting length becomes gradually smaller in the moving direction of the terminal holding member 80 from the primary locking position to the secondary locking position. In this way, by pressing the retracting contact surface 94f against the core wire crimping portion 14, the resilient piece 91 can be smoothly resiliently deformed outward.

The retaining protrusion 93 may also have a surface shaped to reduce an inward projecting length in the moving direction of the terminal holding member 80, similarly to the retracting contact surface 94f. In this way, the contact of the retaining protrusion 93 and the side wall 13b is easily avoided.

Further, the retaining protrusion 93 includes a terminal insertion guiding protrusion 95 on a side opposite to the mating terminal connecting portion 12 with respect to the retracting protrusion 94, i.e. on the rear side.

The inward facing surface of the terminal insertion guide protrusion 95 is formed into a terminal insertion guide surface 95f extending in a direction away from the terminal 10 toward the side opposite to the mating terminal connecting portion 12 (i.e. the rear side) in the extension direction of the cavity 34 (see FIG. 6).

Thus, if the terminal 10 is inserted into the cavity 34 with the terminal holding member 80 located at the primary locking position, the tip part of the terminal 10 contacts the terminal insertion guide surface 95f. In this way, the resilient piece 91 is resiliently deformed outward in the lateral direction, and the temporary locking protrusion 92 is retracted and moved outward from the cavity 34. If the mating terminal connecting portion 12 of the terminal 10 rides over the temporary locking protrusion 92, the resilient piece 91 returns to an original shape and the temporary locking protrusion 92 enters the cavity 34. In this way, the retaining protrusion 93 of the temporary locking protrusion 92 can contact the rear end of the mating terminal connecting portion 12.

With the terminal holding member 80 mounted on the housing 30 at the secondary locking position, at least a part of the temporary locking protrusion 92 may be arranged at a position capable of contacting the terminal in the cavity 34. In this embodiment, the upward facing surface of the temporary locking protrusion 92 is arranged at a position to support the terminal in the cavity 34 from below. For example, an upward facing surface 92f of the temporary locking protrusion 92 is arranged on an extension of the bottom surface of a part for accommodating the mating terminal connecting portion 12, out of the cavity 34 (see FIG. 4). In this way, the terminal 10 is easily stably supported in the cavity 34.

### <Concerning Terminal Holding Operation>

A holding operation example of the terminal 10 is described.

For example, the terminal holding member 80 mounted on the housing 30 at the primary locking position is prepared (see FIG. 5). In this state, the inner locking protrusions 83a and the locking protrusion 83b do not project into the cavities 34, 44. Further, the temporary locking protrusions 92 are located in the cavities 34.

The terminal 10 is inserted into the cavity 34. During the insertion of the terminal 10, the tip part of the terminal 10 contacts the terminal insertion guide surface 95f (see the left cavity 34 of FIG. 6). If the terminal 10 is further pushed, the tip part of the terminal 10 moves forward while contacting the terminal insertion guide surface 95f and pushes the temporary locking protrusion 92 rightward or leftward. In this way, the temporary locking protrusion 92 is retracted and moved outward from the cavity 34, and the terminal 10 can be inserted to the back of the cavity 34.

If the mating terminal connecting portion 12 rides over the temporary locking protrusion 92 forward, the temporary locking protrusion 92 returns to a state projecting into the cavity 34 by a resilient force of the resilient piece 91 returning to the original shape. In this way, the temporary locking protrusion 92 primarily locks the recess 11 of the terminal 10. More specifically, the retaining protrusion 93 retains and locks the mating terminal connecting portion 12 from behind (see FIGS. 6 to 8).

The terminal 10 is inserted into the inner cavity 44 (see FIG. 5). At this time, since the terminals 10 are primarily locked in the cavities 34, an inserting operation of the terminal 10 can be performed without paying attention to the coming-out of the terminal 10 from the cavity 34.

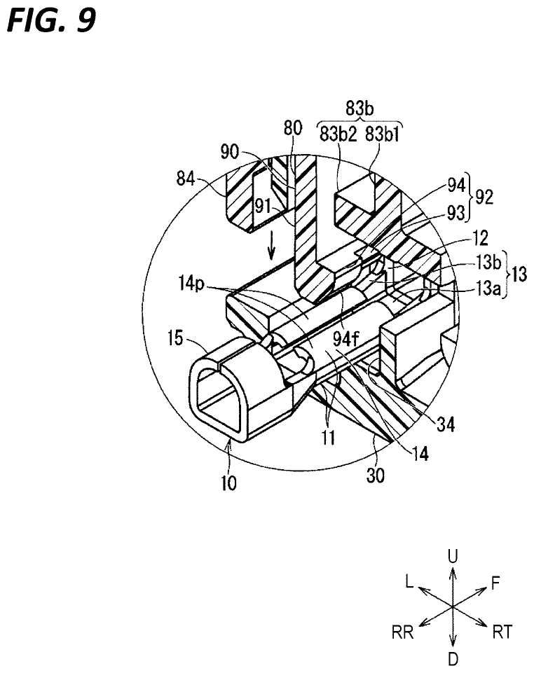

If the inserting operation of the terminals 10 into the inner cavities 44 is finished, the terminal holding member 80 is moved from the primary locking position to the secondary locking position. Then, the retracting contact surfaces 94f of the retracting protrusions 94 contact the curved surfaces of the core wire crimping portions 14 (see FIG. 9). If the terminal holding member 80 is further pushed, the retracting protrusions 94 are pushed outwardly of the core wire crimping portions 14. If the retracting protrusions 94 ride over the core wire crimping portions 14 downward, the locking lances 90 return to the original shape by resilient forces of the resilient pieces 91 returning to the original shape. The upward facing surfaces of the retracting protrusions 94 are exposed in the cavities 34, and arranged at such positions as to be able to support the terminals 10 from below.

It is possible to perform an operation of moving the terminal holding member 80 toward the secondary locking position without paying attention to the escape of the terminals 10 in the cavities 34.

If the terminal holding member 80 moves to the secondary locking position, the inner locking protrusions 83a enter the inner cavities 44 and lock the recesses 11 of the terminals 10 in the inner cavities 44 and the locking protrusion 83b enters the cavities 34 and locks the recesses 11 of the terminals 10 in the cavities 34. In this way, the terminals 10 are suppressed from coming out rearward from the cavities 34, 44.

<effects, Etc.>

According to the connector 20 configured as described above, the terminal holding member 80 is provided with the locking lances 90 for temporarily locking the terminals 10. Thus, the housing 30 needs not be provided with locking lances and the housing 30 can be reduced in size. In this way, the connector 20 capable of temporarily locking the terminals 10 can be further reduced in size.

Further, the terminal holding member 80 can be moved from the primary locking position to the secondary locking position while the retracting contact surfaces 94f of the locking lances are brought into contact with the core wire crimping portions 14 to resiliently deform the locking lances 90 in the directions separating from the terminals 10. At this time, since the retracting contact surfaces 94f contact the core wire crimping portions 14, the production of shavings due to the contact of the locking lances 90 with the terminals 10 is suppressed.

Further, the temporary locking protrusion 92 of the locking lance 90 and the locking protrusion 83b can lock the same recess 11 of the terminal 10. Thus, the terminal 10 may not be separately formed with a location to be primarily locked by the locking lance 90 and a location to be secondarily locked by the locking protrusion 83b. In this way, the terminal 10 can be simplified and reduced in size, which contributes to a size reduction of the connector 20.

Further, the locking lance 90 includes the retaining protrusion 93 located closer to the mating terminal connecting portion 12 than the retracting protrusion 94, and the retracting protrusion 94 projects more toward the terminal 10 than the retaining protrusion 93. Thus, the retracting protrusion 94 is easily brought into contact with the terminal 10 while the contact of the retaining protrusion 93 and the terminal 10 is avoided.

If the retracting protrusion 94 projects more than the retaining protrusion 93 in the moving direction of the terminal holding member 80 to the secondary locking position and the direction toward the terminal 10 orthogonal to the moving direction, the retracting protrusion 94 easily contacts the core wire crimping portion 14 earlier than the retaining protrusion 93. In this way, the contact of the retaining protrusion 93 and the side wall 13b is more reliably avoided and the production of shavings due to the contact of the locking lance 90 with the terminal 10 is suppressed.

When the terminal holding member 80 moves to the secondary locking position, the retracting contact surfaces 94f contact the core wire crimping portions 14 to avoid the contact of the retaining protrusions 93 and the pair of side walls 13b, whereby the production of shavings due to the contact of the locking lances 90 with the terminals 10 is effectively suppressed.

Further, the temporary locking protrusion 92 of the locking lance 90 includes the terminal insertion guide protrusion 95 having the terminal insertion guide surface 95f. Thus, if the terminal 10 is inserted into the cavity 34 with the terminal holding member 80 mounted on the housing 30 at the primary locking position, the terminal 10 contacts the terminal insertion guide surface 95f. In this way, the locking lance 90 can be resiliently deformed in the direction away from the terminal 10. In this way, the terminal 10 can be easily inserted into the cavity 34.

Further, with the terminal holding member 80 mounted on the housing 30 at the secondary locking position, at least a part of the temporary locking protrusion 92 of the locking lance 90 is arranged at the position capable of contacting the terminal 10 in the cavity 34. It is assumed that the recess for the passage of the temporary locking protrusion 92 is formed around the cavity 34. However, the temporary locking protrusion 92 can enter the recess and support the terminal 10 in the cavity 34. Thus, the terminal 10 is stabilized in the cavity 34 as compared to the case where the recess for the passage of the temporary locking protrusion 92 is left as an empty space.

The locking lance 90 is formed to project in the same direction as the locking wall portion 84 from the terminal holding body 82 to be arrangeable in the primary locking opening 50, and resiliently deformed in the lateral direction intersecting the extension direction of the cavity 34. Thus, a configuration for forming the locking lance 90 can be reduced as compared to the case where the locking lance 90 is set in a posture along the extension direction of the cavity 34. In this way, the connector 20 can be reduced in size in the front-rear direction. Note that a locking lance may be formed to be long along the extension direction of the cavity 34.

Further, the locking lance 90 extends to avoid locking with the terminal 10 arranged in the inner cavity 44. Thus, if the terminals 10 are inserted into the inner cavities 44 after the terminals 10 are inserted into the cavities 34 and the locking lances 90 are primarily locked to the terminals 10 and, thereafter, the terminal holding member 80 is moved from the primary locking position to the secondary locking position, the escape of the terminals 10 in the inner cavities 44 can be suppressed. Thus, a configuration for primarily locking the terminals 10 in the inner cavities 44 can be made unnecessary, and the connector 20 can be further simplified and reduced in size.

Since the temporary locking protrusions 92 temporarily lock the terminals 10 in the cavities 34 distant from the terminal holding body 82, large resilient deformation is easy as compared to a configuration for temporarily locking the terminals 10 in the inner cavities 44 near the terminal holding body 82. In this way, the terminal holding member 80 is easily moved toward the secondary locking position.

Further, since the locking protrusions 83b project from the terminal holding body 82 at the positions distant from the locking lances 90, the locking lances 90 are easily resiliently deformed.

Further, since the pair of locking wall portions 84 respectively lock the secondary locking protrusions 66 of the housing 30 at the positions outside the primary locking opening 50 in the front-rear direction along the extension direction of the cavities 34, the terminal holding member 80 can be firmly mounted on the housing 30.

### Modifications

In this embodiment, the retracting contact surface 94f of the retracting protrusion 94 may contact the coating crimping portion 15.

In this embodiment, a configuration for locking the same recess 11 of the terminal 10 by the temporary locking protrusion 92 and the locking protrusion 83b is described. A locking lance for primary locking and a locking protrusion for secondary locking may lock a terminal at different positions.

In this embodiment, an inward facing part of an intermediate part in an extension direction of a locking lance may include a temporary locking protrusion capable of temporarily locking a terminal in an inner cavity.

Note that the respective configurations described in the above embodiment and the respective modifications can be appropriately combined without contradicting each other.

### LIST OF REFERENCE NUMERALS

10 terminal
11 recess
12 mating terminal connecting portion
13 coupling portion
13a bottom portion
13b side wall
14 core wire crimping portion (crimping portion)
14p crimping piece
15 coating crimping portion
20 connector
30 housing
31F front plate portion
31Fa connection hole
32, 42 terminal accommodating portion
34 cavity
44 inner cavity
50 primary locking opening
52 secondary locking opening
56 locking recess
65 primary locking protrusion
66 secondary locking protrusion
80 terminal holding member
82 terminal holding body
83a inner locking protrusion
83b locking protrusion
83b1 intermediate wall portion
83b2 retaining portion
84 locking wall portion
84g retraction recess
85 mounting locking protrusion
90 locking lance
91 resilient piece
92 temporary locking protrusion
92f upward facing surface
93 retaining protrusion
94 retracting protrusion
94f retracting contact surface
95 terminal insertion guide protrusion
95f terminal insertion guide surface
W wire
Wa core wire portion

1. A connector for holding a terminal including a mating terminal connecting portion and a crimping portion to be crimped to a wire end, comprising:
a housing formed with a cavity capable of accommodating the terminal; and
a terminal holding member mountable on the housing at a primary locking position and a secondary locking position,
the terminal holding member including a locking lance temporarily lockable to the terminal in the cavity at the primary locking position and a locking protrusion lockable to the terminal in the cavity at the secondary locking position,
the locking lance including a retracting protrusion having a retracting contact surface, and
the retracting contact surface being formed at a position where the retracting contact surface contacts the crimping portion to resiliently deform the locking lance in a direction separating from the terminal by a movement of the terminal holding member from the primary locking position to the secondary locking position.

212. The connector of claim 1, wherein:
the terminal includes a recess recessed between the mating terminal connecting portion and the crimping portion,
the locking lance primarily locks the recess with the terminal holding member located at the primary locking position, and
the locking protrusion secondarily locks the recess with the terminal holding member located at the secondary locking position.

3. The connector of claim 1, wherein:
the locking lance includes a retaining protrusion located closer to the mating terminal connecting portion than the retracting protrusion,
the retaining protrusion retains and locks the mating terminal connecting portion from the crimping portion side with the terminal holding member located at the primary locking position, and
the retracting protrusion projects more toward the terminal than the retaining protrusion.

4. The connector of claim 3, wherein the retracting protrusion projects more than the retaining protrusion in a moving direction of the terminal holding member from the primary locking position to the secondary locking position and a direction toward the terminal orthogonal to the moving direction.

5. The connector of claim 3, wherein:
the terminal includes a coupling portion coupling the mating terminal connecting portion and the crimping portion,
the coupling portion includes a bottom portion and a pair of side walls rising from both side edges of the bottom portion, and
the retracting contact surface contacts the crimping portion to avoid contact of the retaining protrusion and the pair of side walls when the terminal holding member moves from the primary locking position to the secondary locking position.

6. The connector of claim 1, wherein:
the locking lance includes a terminal insertion guide protrusion located on a side opposite to the mating terminal connecting portion with respect to the retracting protrusion, and
the terminal insertion guide protrusion has a terminal insertion guide surface extending in a direction away from the terminal toward the side opposite to the mating terminal connecting portion in an extension direction of the cavity.

7. The connector of claim 1, wherein at least a part of the locking lance is arranged at a position capable of contacting the terminal in the cavity with the terminal holding member mounted on the housing at the secondary locking position.

8. The connector of claim 1, wherein:
the housing includes a secondary locking opening and a primary locking opening,
the terminal holding member includes a terminal holding body to be mounted into the secondary locking opening and a pair of locking wall portions extending along both sides of the housing from both sides of the terminal holding body,
the locking protrusion is formed to project into the cavity from the terminal holding body, and
the locking lance projects in the same direction as each of the pair of locking wall portions from the terminal holding body to be arrangeable in the primary locking opening and is resiliently deformed along a direction intersecting an extension direction of the cavity.

9. The connector of claim 8, wherein:
the housing includes an inner cavity located closer to the terminal holding body than the cavity, and
the locking lance extends to avoid locking with a terminal arranged in the inner cavity, out of a plurality of the terminals.

10. The connector of claim 8, wherein the locking protrusion projects from the terminal holding body at a position separated from the locking lance.

11. The connector of claim 8, wherein the pair of locking wall portions respectively include mounting locking protrusions to be secondarily locked to the both sides of the housing at positions on both outer sides of the primary locking opening along the extension direction of the cavity.
